(19) United States
(12) Patent Application Publication
(10) Pub. No.: US 2023/0003539 A1
(43) Pub. Date: Jan. 5, 2023

(54) NAVIGATION DEVICE, CONTROL METHOD FOR NAVIGATION DEVICE, AND CONTROL PROGRAM FOR NAVIGATION DEVICE

(71) Applicant: NIPPON SEIKI CO., LTD., Niigata (JP)

(72) Inventor: Takeshi EJIRI, Niigata (JP)

(21) Appl. No.: 17/783,160

(22) PCT Filed: Dec. 25, 2020
(86) PCT No.: PCT/JP2020/048677

§ 371 Date: Jun. 7, 2022

(30) Foreign Application Priority Data
Dec. 27, 2019 (JP) 2019-237912

(51) Int. Cl. G01C 21/36

(52) U.S. Cl. CPC G01C 21/3632; G01C 21/367; G01C 21/3676; G01C 21/365

(57) ABSTRACT

A navigation device includes an image display unit and a display control unit for controlling the display of the image display unit. The display control unit displays, in the image display unit, a map on a fixed scale in the form of a bird's eye view in which the front of the vehicle is overlooked, and displays a moving route by a guide line on the map until the distance to a guide point becomes a first display switching determination distance, when the distance to the guide point becomes the first display switching determination distance or shorter, increases a scale as the guide point is approached, and when the distance to the guide point becomes a second display switching determination distance or shorter, stops the increase of the scale, and displays, in an area where the guide line is displayed, a mark indicating a path at the guide point.

### TECHNICAL FIELD

The present invention relates to a navigation device, a control method for a navigation device, and a control program for a navigation device, and can be applied, for example, to a navigation device which displays an image by a head-up display and executes navigation processing.

### BACKGROUND ART

Conventionally, in route guide display of a navigation device, display forms such as map display, AR display, turn-by-turn display, an intersection enlarged view, a distance bar, and numerical display for distance, have been used.

Here, the map display refers to a display form in which a map is displayed and a moving route is displayed on the map, and the AR display refers to a display form in which navigation information is displayed over actual scenery or the like to perform a route guide. Further, the turn-by-turn display refers to a display form in which a mark indicating the direction of travel, such as a right turn or a left turn, is displayed to perform a route guide, and the intersection enlarged view refers to a display form in which a map is displayed on an enlarged scale at a place where the direction of travel is to be changed, such as an intersection, to perform a route guide. Furthermore, the distance bar refers to a display form in which a distance to a landmark object, such as an intersection, is displayed in the form of a bar graph, and the numerical display for distance refers to a display form in which a distance to a landmark object, such as an intersection, is displayed by a numerical value instead of the distance bar.

The navigation device executes route guide processing by any one of the above display forms, and further by a combination of the above display forms. Further, the route guide processing is executed by switching the above display forms according to a distance to the intersection or the like.

Regarding the display of such a route guide, Patent Literature 1, for example, discloses a configuration of scrolling or zooming in or out a map being displayed.

### PRIOR ART DOCUMENT

### Patent Document

Patent Literature 1: JP 2010-204379 A

### SUMMARY OF THE INVENTION

### Problems to be Solved by the Invention

Meanwhile, the conventional route guide display has a problem in which it is still practically insufficient in terms of usability.

That is, when a route guide is to be performed by any one of the above-described display forms, or further by a combination of the above display forms, depending on a distance to the intersection or the like, there arises a problem in which the point for a right turn, a left turn, etc., is hard to be ascertained surely and intuitively, and as a result, the path may be incorrectly recognized.

In order to resolve such a problem, one possible step is to perform the route guide by switching the display forms according to a distance to the intersection or the like. However, in this case, there arises a problem in which a burden on a driver to ascertain the substance is increased because a viewpoint will be changed if the display form is changed, and moreover, because the display form itself is switched.

The present invention has been conceived in view of the above circumstances, and the present invention makes it possible to effectively avoid an increase in a burden on a driver, and allow the driver to surely and intuitively ascertain the point for a right turn, a left turn, etc.

### Solution to Problem

In order to resolve the problem concerned, the invention of claim 1 relates to a navigation device which executes navigation processing in a vehicle, in which the navigation device is provided with: an image display unit which displays an image to be used for the navigation processing; and a display control unit which controls the display of the image display unit. The display control unit: displays, by the image display unit, a map on a fixed scale in the form of a bird's-eye view overlooking ahead of the vehicle, and displays a moving route on the map by a guide line, until a distance to a guide point reaches a first display switching determination distance; increases the scale as the guide point is approached, when the distance to the guide point becomes less than or equal to the first display switching determination distance; and stops the increase of the scale, and displays a mark indicating a path at the guide point at a display place of the guide line, when the distance to the guide point becomes less than or equal to a second display switching determination distance.

According to the configuration of claim 1, until a distance to the guide point reaches the first display switching determination distance, a map is displayed on the fixed scale in the form of a bird's-eye view overlooking ahead of the vehicle, and a moving route is displayed on this map by the guide line. Therefore, the moving route can be intuitively ascertained while the guide point is being approached.

Further, when the distance to the guide point becomes less than or equal to the first display switching determination distance, the scale is increased as the guide point is approached. Therefore, it is possible to reduce a burden caused by the switching of the display and allow the driver to intuitively ascertain that the guide point is approaching.

Furthermore, when the distance to the guide point becomes less than or equal to the second display switching determination distance, the increase of the scale is stopped and a mark indicating the path in the guide point is displayed at the display place of the guide line. Therefore, it is possible to display a change of the path by displaying a mark such as an arrow on a detailed map, whereby an increase in a burden on the driver caused by the switching of the display can be effectively avoided, and the point for a right turn, a left turn, etc., can be surely and intuitively ascertained.

The invention of claim 2 is based on the configuration of claim 1, in which the display control unit displays the guide line to be of a fixed width relative to a width of a road on the map.

According to the configuration of claim 2, by the display of the guide line at a fixed width, it is possible to make the moving route easily recognized.

The invention of claim 3 is based on the configuration of claim 1 or claim 2, in which the mark is a mark in which an arrow is placed at one end of a strip-shaped part, and the display control unit displays a width of the strip-shaped part to be of a same width as the guide line.

According to the configuration of claim 3, the path can be displayed while effectively avoiding a sudden change in the display. Also, after that, the display of the guide line may be stopped and only the mark may be displayed, whereby an increase in a burden on the driver can be further reduced, and a change of the path can be reliably ascertained.

Further, the invention of claim 4 is based on the configuration of any one of claim 1, claim 2, and claim 3, in which the image display unit displays the image by a virtual image in a space ahead of the driver such that scenery ahead is visually recognizable by the driver, and the display control unit: displays, in the display of the map, at least a road on the map at brightness visually recognizable by the driver until the distance to the guide point reaches the first display switching determination distance; and reduces the brightness of at least the road on the map, when the distance to the guide point becomes less than or equal to the first display switching determination distance.

According to the configuration of claim 4, the visibility of the scenery ahead can be increased when the guide point is approached, and the point for a right turn, a left turn, etc., can be ascertained more surely.

The invention of claim 5 relates to a control method for a navigation device which executes navigation processing in a vehicle, in which the navigation method includes: displaying a map on a fixed scale in the form of a bird's-eye view overlooking ahead of the vehicle, and displaying a moving route on the map by a guide line, until a distance to a guide point reaches a first display switching determination distance; increasing the scale as the guide point is approached, when the distance to the guide point becomes less than or equal to the first display switching determination distance; and stopping the increase of the scale, and displaying a mark indicating a path at the guide point at a display place of the guide line, when the distance to the guide point becomes less than or equal to a second display switching determination distance.

According to the configuration of claim 5, until a distance to the guide point reaches the first display switching determination distance, a map is displayed on the fixed scale in the form of a bird's-eye view overlooking ahead of the vehicle, and a moving route is displayed on this map by the guide line. Therefore, the moving route can be intuitively ascertained while the guide point is being approached.

Further, when the distance to the guide point becomes less than or equal to the first display switching determination distance, the scale is increased as the guide point is approached. Therefore, it is possible to reduce a burden caused by the switching of the display and allow the driver to intuitively ascertain that the guide point is approaching.

Furthermore, when the distance to the guide point becomes less than or equal to the second display switching determination distance, the increase of the scale is stopped and a mark indicating the path in the guide point is displayed at the display place of the guide line. Therefore, it is possible to display a change of the path by displaying a mark such as an arrow on a detailed map, whereby an increase in a burden on the driver caused by the switching of the display can be effectively avoided, and the point for a right turn, a left turn, etc., can be surely and intuitively ascertained.

The invention of claim 6 relates to a control program for a navigation device which executes navigation processing in a vehicle, in which the control program causes predetermined processing procedures to be executed by way of execution in an arithmetic processing circuit, the processing procedures including: a wide-area map display step of displaying a map on a fixed scale in the form of a bird's-eye view overlooking ahead of the vehicle, and displaying a moving route on the map by a guide line, until a distance to a guide point reaches a first display switching determination distance; an enlarged map display step of increasing the scale as the guide point is approached, when the distance to the guide point becomes less than or equal to the first display switching determination distance; and an AR display step of stopping the increase of the scale, and displaying a mark indicating a path at the guide point at a display place of the guide line, when the distance to the guide point becomes less than or equal to a second display switching determination distance.

According to the configuration of claim 6, until a distance to the guide point reaches the first display switching determination distance, a map is displayed on the fixed scale in the form of a bird's-eye view overlooking ahead of the vehicle, and a moving route is displayed on this map by the guide line. Therefore, the moving route can be intuitively ascertained while the guide point is being approached.

Further, when the distance to the guide point becomes less than or equal to the first display switching determination distance, the scale is increased as the guide point is approached. Therefore, it is possible to reduce a burden caused by the switching of the display and allow the driver to intuitively ascertain that the guide point is approaching.

Furthermore, when the distance to the guide point becomes less than or equal to the second display switching determination distance, the increase of the scale is stopped and a mark indicating the path in the guide point is displayed at the display place of the guide line. Therefore, it is possible to display a change of the path by displaying a mark such as an arrow on a detailed map, whereby an increase in a burden on the driver caused by the switching of the display can be effectively avoided, and the point for a right turn, a left turn, etc., can be surely and intuitively ascertained.

### Effect of the Invention

According to the present invention, it is possible to effectively avoid an increase in a burden on the driver, and the point for a right turn, a left turn, etc., can be surely and intuitively ascertained.

### BRIEF DESCRIPTION OF THE DRAWINGS

FIG. 1 is a diagram showing a navigation device according to a first embodiment of the present invention.

FIG. 2 is an illustration to be used for describing the operation of the navigation device of FIG. 1.

### MODE FOR CARRYING OUT THE INVENTION

### 1. First Embodiment

[Overall Configuration]

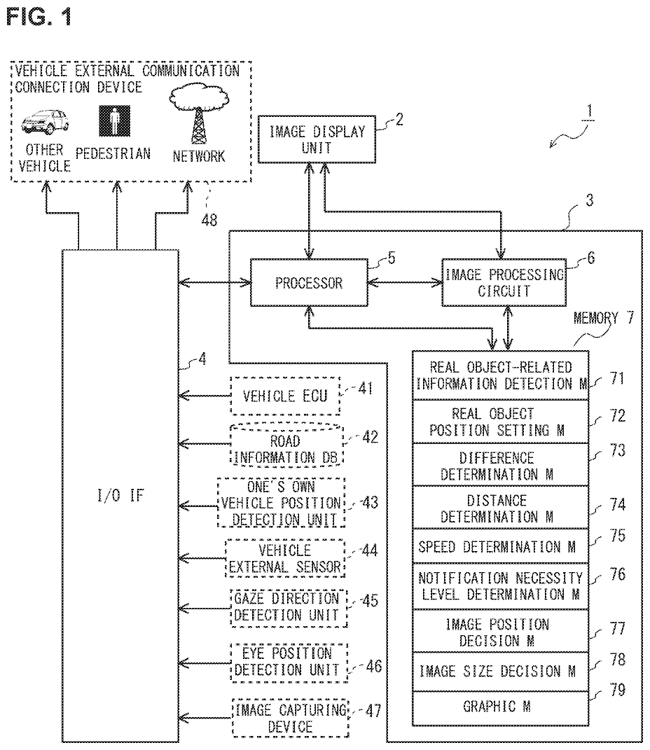

FIG. 1 is a block diagram showing a navigation device according to a first embodiment of the present invention. A navigation device 1 in the above is an information terminal device which executes navigation processing, etc., in a vehicle.

The navigation device 1 is provided with an image display unit 2 and a display control unit 3, and is further provided with an input/output interface (I/O IF) 4.

Here, the input/output interface 4 is a part which performs data communication with various devices provided in the vehicle and with devices outside the vehicle. The input/output interface 4 acquires vehicle information necessary for navigation processing, such as a vehicle speed pulse, from a vehicle ECU (Electronic Control Unit) 41, which is a controller provided in the vehicle. The input/output interface 4 acquires, from a road information database (DB) 42, which is a database in which pieces of road information and map information are recorded, information on roads and the like to be used for a route search and map display. Also, the input/output interface 4 acquires, from a one's own vehicle position detection unit 43 which detects a current position by a GPS (Global Positioning System), etc., current positional information on the vehicle of one's own. Further, the input/output interface 4 acquires acceleration information from a vehicle external sensor 44, which is a three-dimensional acceleration sensor. The navigation device 1 then detects a change in the direction of travel of the vehicle from this acceleration information. Furthermore, the input/output interface 4 acquires, from a gaze direction detection unit 45 and an eye position detection unit 46, information on a driver's gaze direction and information on the eye position to be obtained by processing an image capturing result of the driver. The navigation device 1 then sets an image display position on the basis of the information on the gaze direction and the information on the eye position. Moreover, the input/output interface 4 acquires a plurality of image capturing results of the scenery ahead of the vehicle of one's own from an image capturing device 47. The navigation device 1 then detects an intersection, etc., from processing on the image capturing results, and further detects a distance to the intersection, etc.

The navigation device 1 also has the function of sending and receiving an e-mail, for example. The input/output interface 4 inputs and outputs necessary data to and from a vehicle external communication connection device 48 corresponding to information terminal devices provided in other vehicles, information terminal devices carried by pedestrians, and information terminal devices provided on a network.

The image display unit 2 is a part which displays an image to be used for navigation processing, and a head-up display is applied in the present embodiment. The image display unit 2 is configured to emit emission light from an image display panel toward a windshield, and to provide reflected light from the windshield to the driver, whereby various images are displayed by a virtual image in a space ahead of the driver such that the driver can visually recognize the scenery ahead. Note that a head-mounted display may be applied instead of a head-up display, and various kinds of configurations can be widely applied.

The display control unit 3 is a controller which controls the display of the image display unit 2, and is provided with a processor 5, an image processing circuit 6, and a memory 7. The image processing circuit 6 forms image data by using an image formed by the processing of the processor 5, and outputs the image data to the image display unit 2.

The processor 5 is an arithmetic processing circuit which executes a control program of the navigation device, and the display control unit 3 executes predetermined processing procedures related to navigation processing by way of execution of the control program by the processor 5.

The memory 7 constitutes a work area of the processor 5, and various modules are configured by execution of programs by the processor 5. Note that FIG. 1 illustrates modules related to route guide processing.

Here, a real object-related information detection module (real object-related information detection M) 71 is a module which processes an image capturing result of the image capturing device 47, and acquires information necessary for detecting a point (hereinafter referred to as a guide point) for providing instructions for a right turn, a left turn, and the like, such as an intersection. A real object position setting module (real object position setting M) 72 is a module which detects the position of the guide point, on the basis of a result of detection by the real object-related information detection module 71. A difference determination module (difference determination M) 73 is a module which determines a distance of deviation from a moving route. A distance determination module (distance determination M) 74 is a module which determines a distance to the guide point. A speed determination module (speed determination M) 75 is a module which detects and determines a traveling speed from the vehicle speed pulse. A notification necessity level determination module (notification necessity level determination M) 75 is a module which determines the degree of importance of notification from results of determination by the difference determination module 73, the distance determination module 74, and the speed determination module 75. An image position decision module (image position decision M) 76 is a module which decides on a display position for an image to be used for display in the image display unit 2, on the basis the information on the driver's gaze direction and the information on the eye position. An image size decision module (image size decision M) 77 is a module which decides on the size of an image for use by the image position decision module 76. A graphic module (graphic M) 78 is a module which generates an image to be displayed in the image display unit 2, on the basis of results of processing by the image position decision module 76 and the image size decision module 77.

[Route Guide Display]

When a search for a moving route is instructed by the driver, the display control unit 3 searches for the moving route on the basis of the current positional information detected by the one's own vehicle position detection unit 43, displays a map on the basis of the records of the road information database 42, and displays the moving route to a destination. Also, when a route guide according to this moving route is instructed, the route guide processing is executed.

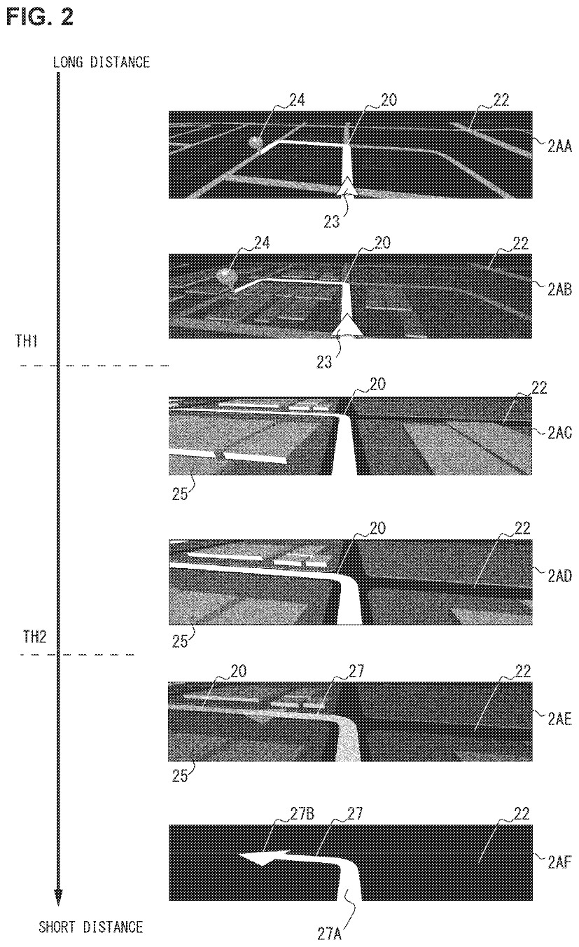

FIG. 2 is a plan view indicating display screens (route guide displays) 2AA to 2AF to be presented by the image display unit 2 in the route guide processing. The navigation device 1 displays the display screens 2AA to 2AF related to the route guide processing in a rectangular area in front of the driver. Note that FIG. 2 is a drawing indicating the respective corresponding display screens formed by the image display unit 2 according to a distance to the guide point. Thus, the more the part is black in the display screens 2AA to 2AF, the easier it is for the driver to visually recognize the scenery ahead.

The display control unit 3 starts display of route guide information when a distance to the guide point becomes less than or equal to a display start distance (e.g., 300 m), on the basis of a result of determination by the distance determination module 74. Further, as indicated by reference numerals 2AA and 2AB, until the distance to the guide point reaches a first display switching determination distance TH1 (e.g., 200 m), the display control unit 3 displays a map on a fixed scale in the form of a bird's-eye view overlooking ahead of the vehicle, and displays a moving route on this map by a guide line 20 (i.e., a wide-area map display step). If practically sufficient, the map may be displayed at all times until the distance to the guide point reaches the first display switching determination distance TH1.

Note that the fixed scale mentioned above may be a fixed value or a scale instructed by the driver.

Also, the display start distance and the first display switching determination distance TH1 may be fixed values or distances instructed by the driver, and may be set to correspond to the scale instructed by the driver or may be set in accordance with the degree of congestion in the surroundings.

As a result, with the navigation device 1, a moving route can be confirmed from a wide-area map to ascertain a path change place until the distance to the guide point reaches the first display switching determination distance TH1. In other words, the moving route can be intuitively ascertained while the guide point is being approached.

Here, on the display screens 2AA and 2AB, at least a road 22 on the map is displayed at brightness visually recognizable by the driver, and the guide line 20 is displayed at brightness higher than that of the road 22 and in a color different from that of the road 22, whereby the moving route can be intuitively ascertained.

In addition, the guide line 20 is displayed to be of a fixed width relative to the width of the road 22. Thus, similarly for the road 21, the farther the guide line 20 is, the narrower the guide line 20 is made to correspond to the road 22, whereby the moving route is made easily recognizable.

In addition, the display screens 2AA and 2AB display a one's own vehicle mark 23 indicating the position of the vehicle of one's own, a destination mark 24 indicating a destination if the destination exists on the map, and also a mark corresponding to a well-known point (e.g., a holiday resort or sight-seeing area), if there is any on the map.

In addition, on the display screens 2AA and 2AB, places (such as vacant land between roads or farmland) where no major buildings or the like is existent are displayed at brightness lower than that of the road 22, whereby visibility of forward view is further improved.

In addition, a major building 25 is displayed at brightness higher than that of the road 22 but lower than that of the guide line 20. By doing so, a landmark object on the moving route is enabled to be easily confirmed on the map without impairing the visibility of the guide line 20.

The display screen is displayed in this way, and when a current position of the vehicle is changed due to a travel motion, the display control unit 3 causes the display of the display screen to be varied to correspond to this position change.

As indicated by reference numerals 2AC, 2AD, 2AE, and 2AF, when a distance to the guide point becomes less than or equal to the first display switching determination distance TH1, the display control unit 3 displays the map such that the scale is increased as the guide point is approached until the distance to the guide point reaches a second display switching determination distance TH2 (e.g., 50 m) (i.e., an enlarged map display step).

The navigation device 1 can thereby reduce a burden caused by the switching of the display, and the driver is enabled to ascertain the guide point intuitively from a detailed map.

Here, the scale increase is executed stepwise (e.g., in two stages of 200 m and 100 m, which correspond to the distances to the guide point) by repeating the processing of gradually increasing the scaling factor in a fixed transition time (e.g., one second), as the guide point is approached. Alternatively, the scale may be continuously increased as the distance to the guide point is decreased.

Here, the second display switching determination distance TH2 may be a fixed value or a distance instructed by the driver, and may be set to correspond to the scale instructed by the driver or may be set in accordance with the degree of congestion in the surroundings.

In addition, when the map is displayed with the scale increased in this way, and the distance to the guide point reaches a road display switching distance (e.g., 100 m), which is less than the first display switching determination distance TH1, and is of a distance before reaching the second display switching determination distance TH2, the display control unit 3 reduces the brightness of the road 22 on the map in conjunction with the increase in the scale of the map. Further, in contrast with this, the brightness is increased for an area between the roads 22, whereby the high brightness and the low brightness relationship between the road-to-road area and the road 22 is reversed.

The above reduction and increase in the brightness may not be in conjunction with the stepwise increase in the scale of the map, but the brightness may be gradually varied as the guide point is approached. Further, the road display switching distance can be set variously within a range of the first display switching determination distance TH1 or less.

Furthermore, by reducing only the brightness of the road 22 and not increasing the brightness of the area between the roads 22, the high brightness and the low brightness relationship may be reversed.

As a result, with the navigation device 1, the visibility of the scenery ahead can further be increased when the guide point is approached, and the point for a right turn, a left turn, etc., can be ascertained more surely.

The scale is increased in this way, and as indicated by reference numerals 2AE and 2AF, when the distance to the guide point becomes less than or equal to the second display switching determination distance TH2, the increase of the scale is stopped, and a mark 27 indicating a path at the guide point is displayed at a display place of the guide line 20 (i.e., an AR display step).

In the present embodiment, the mark 27 is a mark in which an arrow 27B is placed at one end of a strip-shaped part 27A. The mark 27 is displayed in the same color as that of the guide line 20, and the width of the strip-shaped part 27A is displayed to be of the same width as the guide line 20. Alternatively, the display may be performed by a color different from that of the guide line.

By this feature, it is possible to display the path while reducing a sudden change in the display due to a start of the display of the mark 27.

The display control unit 3 displays the mark 27 in this way, and when the guide point is further approached, the brightness of the guide line 20 is gradually reduced and the display of the guide line 20 is stopped, whereby only the mark 27 is displayed (display screen 2AF). This feature also enables the path to be even more reliably ascertained. The scale is configured such that when only the mark 27 is displayed as described above, parts other than the road 22 are not displayed. Therefore, the forward view is in no way obstructed in the parts other than the mark 27, and the visibility is further improved.

The display control unit 3 displays the mark 27 in this way and causes the size of the mark 27 to be varied to correspond to a change in the position of the vehicle of one's own, and further changes, when the direction of travel changes, the direction of the mark 27 to correspond to this change. When the change in the direction of travel is complete, by displaying display screens 22AA to 22AF as described above according to a distance to the next guide point, display of a display screen is gradually started by, for example, fade-in processing.

According to the above configuration, until a distance to a guide point reaches a first display switching determination distance, a map is displayed on a fixed scale in the form of a bird's-eye view overlooking ahead of a vehicle, and a moving route is displayed on this map by a guide line; when the distance to the guide point becomes less than or equal to the first display switching determination distance, the scale is increased as the guide point is approached; and when the distance to the guide point becomes less than or equal to a second display switching determination distance, the increase of the scale is stopped and a mark indicating a path is displayed at a display place of the guide line. By this feature, while the guide point is being approached, the moving route can be ascertained intuitively by a wide-area map, and by use of a map in which the scale is increased as the guide point is approached, approach to the guide point can be intuitively ascertained by the driver without placing a burden on the driver caused by the switching of the display. Furthermore, when the guide point is approached, a change of the path can be confirmed from a mark on the map. By this feature, it is possible to effectively avoid an increase in a burden on the driver caused by the switching of the display, and the point for a right turn, a left turn, etc., can be surely and intuitively ascertained.

Further, as the guide line is displayed to be of a fixed width relative to the width of the road on the map, it is possible to make the moving route easily recognized.

Furthermore, since the mark is a mark in which an arrow is placed at one end of a strip-shaped part, and the width of the strip-shaped part is displayed to be of the same width as the guide line, the path can be displayed while effectively avoiding a sudden change in the display. Also, after that, the display of the guide line may be stopped and only the mark may be displayed, whereby an increase in a burden on the driver can be further reduced, and a change of the path can be reliably ascertained.

In addition, in a configuration in which an image is displayed by a virtual image in a space ahead of the driver such that the driver can visually recognize the scenery ahead, at least the road on the map is displayed at brightness visually recognizable by the driver until a distance to the guide point reaches the first display switching determination distance, and when the distance becomes less than or equal to the first display switching determination distance, the brightness of at least the road is reduced. By this feature, visibility of the scenery ahead can be increased, and the point for a right turn, a left turn, etc., can be ascertained more surely.

[Other Embodiments]

Specific configurations suitable for the implementation of the present invention have been described in detail above. However, the present invention can be modified variously from the above-described embodiment within the scope not departing from the gist of the present invention.

### DESCRIPTION OF REFERENCE NUMERALS

1 Navigation device

2 Image display unit

3 Display control unit

4 Input/output interface

5 Processor

6 Image processing circuit

7 Memory

20 Guide line

22 Road

27 Mark

1. A navigation device which executes navigation processing in a vehicle, the navigation device comprising: an image display unit which displays an image to be used for the navigation processing; and a display control unit which controls the display of the image display unit, wherein the display control unit: displays, by the image display unit, a map on a fixed scale in the form of a bird's-eye view overlooking ahead of the vehicle, and displays a moving route on the map by a guide line, until a distance to a guide point reaches a first display switching determination distance; increases the scale as the guide point is approached, when the distance to the guide point becomes less than or equal to the first display switching determination distance; and
stops the increase of the scale, and displays a mark indicating a path at the guide point at a display place of the guide line, when the distance to the guide point becomes less than or equal to a second display switching determination distance.

2. The navigation device according to claim 1, wherein the display control unit displays the guide line to be of a fixed width relative to a width of a road on the map.

3. The navigation device according to claim 1, wherein: the mark is a mark in which an arrow is placed at one end of a strip-shaped part; and the display control unit displays a width of the strip-shaped part to be of a same width as the guide line.

4. The navigation device according to claim 1, wherein the image display unit displays the image by a virtual image in a space ahead of a driver such that scenery ahead is visually recognizable by the driver, and
the display control unit:
displays, in a display of the map, at least a road on the map at brightness visually recognizable by the driver until the distance to the guide point reaches the first display switching determination distance; and
reduces the brightness of at least the road on the map, when the distance to the guide point becomes less than or equal to the first display switching determination distance.

5. A control method for a navigation device which executes navigation processing in a vehicle, the navigation method comprising:
displaying a map on a fixed scale in the form of a bird's-eye view overlooking ahead of the vehicle, and displaying a moving route on the map by a guide line, until a distance to a guide point reaches a first display switching determination distance; increasing the scale as the guide point is approached, when the distance to the guide point becomes less than or equal to the first display switching determination distance; and
stopping the increase of the scale, and displaying a mark indicating a path at the guide point at a display place of the guide line, when the distance to the guide point becomes less than or equal to a second display switching determination distance.

6. A control program for a navigation device which executes navigation processing in a vehicle, in which the control program causes predetermined processing procedures to be executed by way of execution in an arithmetic processing circuit, the processing procedures comprising: a wide-area map display step of displaying a map on a fixed scale in the form of a bird's-eye view overlooking ahead of the vehicle, and displaying a moving route on the map by a guide line, until a distance to a guide point reaches a first display switching determination distance;
an enlarged map display step of increasing the scale as the guide point is approached, when the distance to the guide point becomes less than or equal to the first display switching determination distance; and an AR display step of stopping the increase of the scale, and displaying a mark indicating a path at the guide point at a display place of the guide line, when the distance to the guide point becomes less than or equal to a second display switching determination distance.
